(19) United States
(12) Patent Application Publication
(10) Pub. No.: US 2008/0275205 A1
(43) Pub. Date: Nov. 6, 2008

(54) Process For Preparing Aminoalkylpolysiloxanes

(75) Inventors: Christian Herzig, Waging (DE); Daniel Schildbach, Neuoetting (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/111,287

(22) Filed: Apr. 29, 2008

(30) Foreign Application Priority Data
May 2, 2007 (DE) 10 2007 020 569.6

(51) Int. Cl. C08G 77/06; C08G 77/08

(52) U.S. Cl. 528/14; 528/38; 528/31

(57) ABSTRACT

A process for preparing aminoalkylpolysiloxanes involves (i) mixing
(1) aminoalkylsilane hydrolyzate

(ARaSiO_{(3-a)/2})ₘ(R¹O_{1/2})ₚ with (I)
(2) linear and/or branched organopolysiloxanes

$${{R}_{x} ( {OR}^{1} )}_{y} {SiO}_{\frac{4 - ( x + y )}{2}} \qquad ( II )$$

until a dispersion is obtained,
where
A is a monovalent SiC-bonded hydrocarbon radical containing at least one amino group,
a is 0 or 1,
m is from 2 to 500,
p is at least 2,
x is 0, 1, 2 or 3, and
y is 0 or 1,
   and at least 10 silicon atoms on average per molecule are present in the organopolysiloxane (2),
(ii) reacting (1) and (2) in dispersion in the presence of a basic catalyst until a substantially clear mixture is obtained, and
(iii) neutralizing the basic catalyst.

### BACKGROUND OF THE INVENTION

1. Field of the Invention

The invention relates to a process for preparing aminoalkylpolysiloxanes.

2. Background Art

The typically practiced processes for preparing aminoalkyl-functional siloxanes proceed from aminoalkylsilanes which are equilibrated into OH— or Me-capped polysiloxanes. In individual versions, these methods differ usually in the type and amount of the catalysts, required to establish an equilibrium, in the manner of catalyst neutralization at the end of the reaction and, in some cases, in the use of various carbinols for capping and stabilization of the polymers obtained. In the case of aminoalkylpolydimethylsiloxanes, equilibration simultaneously involves the formation of low molecular weight volatile byproducts. These byproducts are unwanted in most applications, and therefore must be removed in a separate physical process. This entails increased process complexity, usually also associated with yield losses, and is economically unattractive, specifically in the case of commodities. For this reason, industrial optimization measures in this field are focused on minimizing the proportion of volatile by-products.

As described in EP 382 366 A, this can be achieved by use of particular hydroxide catalysts which catalyze only the condensation of linear diorganopolysiloxanes with terminal silanol groups. The linear diorganopolysiloxanes may also have functional groups, such as aminoalkyl groups. In this process the “raw materials” used are already OH-capped aminoalkylsiloxanes, but there is no description of how these starting materials may be prepared with low losses.

U.S. Pat. No. 3,890,269 (corresponding to DE 2 339 761 A) describes a process for preparing aminoalkylsiloxanes, in which cyclic siloxanes are equilibrated with aminoalkylsilanes or their hydrolyzates in the presence of an alkali metal catalyst, considerable amounts of volatile siloxanes being obtained in the equilibration.

### SUMMARY OF THE INVENTION

It was an object of the invention to provide a process for preparing aminoalkylpolysiloxanes, in which the reaction times are short; in which aminoalkylpolysiloxanes having a low residual volatility are obtained, especially a low content of cyclic siloxanes such as cyclooctamethyltetrasiloxane (D₄); which are storage-stable; and in which especially, linear aminoalkylpolysiloxanes with terminal silanol groups (Si—OH) are obtained. These and other objects are surprisingly achieved through the reaction of a dispersion of an aminoalkylsilane hydrolysate and an organopolysiloxane bearing Si—OH or Si-alkoxy groups, in the presence of a basic catalyst, followed by neutralization of the catalyst.

### DETAILED DESCRIPTION OF THE PREFERRED EMBODIMENT(S)

The invention provides a process for preparing aminoalkylpolysiloxanes by

(i) mixing
(1) aminoalkylsilane hydrolyzate(s) of the general formula

(ARaSiO_{(3-a)/2})ₘ(R¹O_{1/2})ₚ (I) and
(2) organopolysiloxane(s) composed of units of the general formula

$${{R}_{x} ( {OR}^{1} )}_{y} {SiO}_{\frac{4 - ( x + y )}{2}} \qquad ( II )$$

until a dispersion is obtained
where
R is the same or different and is a monovalent, optionally halogenated hydrocarbon radical having from 1 to 18 carbon atoms,
R¹ is a hydrogen atom or an alkyl radical which has from 1 to 4 carbon atoms and may contain one or two separate oxygen atoms, and is preferably a hydrogen atom,
A is a monovalent SiC-bonded hydrocarbon radical which contains from 1 to 4 separate basic nitrogen atoms,
a is 0 or 1, preferably 1,
m is an integer from 2 to 500—preferably from 2 to 50, and
p is an integer of at least 2, preferably an integer from 2 to 10,
x is 0, 1, 2 or 3,
y is 0 or 1,
with the proviso that an average of at least 10 silicon atoms, preferably at least 20 silicon atoms, per molecule are present in the organopolysiloxane (2),
(ii) reacting amino alkylsilane hydrolyzate (1) and organopolysiloxane (2) in the dispersion in the presence of a basic catalyst (3) until a substantially clear mixture is obtained, and
(iii) stopping the reaction by neutralizing the basic catalyst (3).

In step (i) preferance is given to using an organopolysiloxane (2) which contains an average of at least two R¹O radicals per molecule.

It is commonly known in the art that equilibrations with elimination and reformation of Si—O—Si bonds proceed more slowly than condensation reactions of siloxanols. However, it has surprisingly been found that in the case of reaction of amino alkylsilane hydrolyzate (1), even in the silanol form, with organopolysiloxane (2), likewise in the silanol form, the aminoalkylsiloxane is incorporated into the organopolysiloxane (2) in the form of separate aminoalkylsilane units before significant condensation of the siloxanols occurs. It is likewise surprising that this rapid redistribution reaction generates only very small amounts of volatile cyclosiloxanes.

The process of the invention has the advantage that aminoalkylpolysiloxanes which have a low residual volatility, i.e. a low content of cyclic siloxanes, preferably below 1% by weight, and more preferably of below 0.7% by weight, may be obtained.

Compared to frequently practiced condensation processes of aminoalkylpolysiloxanes with polydimethylsiloxanediols, the process of the invention has the advantage that the product viscosities are only moderately increased compared to the reactants. The viscosity quotient of product/reactant mixture can usually be kept below 4, while it is usually above 10 in condensation processes. If desired, this is also possible in the process according to the invention by prolonging the reaction time, but usually, lower product viscosities are desired for reasons of simple handling. Condensation processes inevitably include the combination of several educts (while forming very small cleavage products) such that a considerable increase in viscosity always results therefrom.

The present process is particularly suitable for preparing aminoalkylsiloxanediols with virtually quantitative SiOH capping of the chain ends, which is either barely achievable at all, or is achievable only with complicated subsequent procedures when aminoalkylsilanes are used. Aminoalkylpolysiloxanes of the type producible by the subject invention are surprisingly storage-stable, and may be used, for example, to prepare aminoalkylsiloxane high polymers, for example in emulsion, as described in WO 2006/015740. In this case, aminoalkylsilane hydrolyzate (1) with R¹O termination is used, where R¹ is hydrogen. The proportion of R¹ defined as hydrogen is then preferably greater than 90 mol %, more preferably greater than 98 mol %, and most preferably about 100 mol %. The same also applies to the end groups of the organopolysiloxane (2).

Examples of hydrocarbon radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radicals; alkaryl radicals such as the o-, m-, and p-tolyl radicals, xylyl radicals and ethylphenyl radicals; and aralkyl radicals such as the benzyl radical and the α- and β-phenylethyl radicals.

Examples of halogenated R radicals are haloalkyl radicals such as the 3,3,3-trifluoro-n-propyl radical, the 2,2,2,2′,2′,2′-hexafluoroisopropyl radical, the heptafluoroisopropyl radical, and haloaryl radicals such as the o-, m- and p-chlorophenyl radicals.

The R radical is preferably a monovalent hydrocarbon radical having from 1 to 6 carbon atoms, particular preference being given to the methyl radical.

Examples of R¹ are H—, CH₃—, CH₃CH₂—, (CH₃)₂CH—, CH₃CH₂CH₂—, CH₃CH₂CH₂CH₂—, CH₃CH₂OCH₂CH₂—, CH₃CH₂OCH₂— and CH₃OCH₂CH₂-radicals.

A in formula (I) is preferably a radical of the formula

—R²—[NR³—R⁴—]_{g}NR³₂

where R² is a divalent linear or branched hydrocarbon radical having from 1 to 18 carbon atoms,
R³ is as defined for R¹ or is an acyl radical, preferably a hydrogen atom,
R⁴ is a divalent hydrocarbon radical having from 1 to 6 carbon atoms and
g is 0, 1, 2, 3 or 4, preferably 0 or 1.

Preferred examples of A radicals are:
H₂N(CH₂)₃ —,
H₂N(CH₂)₂NH(CH₂)₃—,
H₂N(CH₂)₂NH(CH₂)CH(CH₃)CH₂—,
(cyclohexyl)NH(CH₂)₃—,
CH₃NH(CH₂)₃—,
(CH₃)₂N(CH₂)₃—,
CH₃CH₂NH(CH₂)₃—,
(CH₃CH₂)₂N(CH₂)₃—,
CH₃NH(CH₂)₂NH(CH₂)₃—,
(CH₃)₂N(CH₂)₂NH(CH₂)₃—,
CH₃CH₂NH(CH₂)₂NH(CH₂)₃—,
(CH₃CH₂)₂N(CH₂)₂NH(CH₂)₃—,
   and their partly or fully acetylated forms.

Particularly preferred examples of A radicals are:
H₂N(CH₂)₃—,
H₂N(CH₂)₂NH(CH₂)₃—,
(cyclohexyl)NH(CH₂)₃—,
(acetyl)-NH(CH₂)₂NH(CH₂)₃—, and
(acetyl)-NH(CH₂)₂N(acetyl)(CH₂)₃—,

The aminoalkylsilane hydrolyzates (1) are preferably prepared from aminoalkyl-functional dialkoxysilanes, such as aminopropylmethyldimethoxysilane or aminoethylaminopropylmethyldimethoxysilane, by hydrolysis in water. This specific substance group has a linear structure with preferably from 2 to 50 siloxy units. Aminoalkylsilane hydrolyzate (1) can in principle be used with any degree of polymerization. For handling reasons, however, viscosities below 10,000 mPa·s at 25° C. are preferred, especially hydrolyzates with viscosities below 2000 mPa·s at 25° C.

The aminoalkylsilane hydrolyzates (1) preferably have amine group concentrations of from about 5 to about 12 meq/g. The A radical may contain primary, secondary and/or tertiary amine groups, and of course mixtures of these.

The aminoalkylsilane hydrolyzates (1) are therefore preferably those of the general formula

HO(ARSiO)ₘ H (III),

where R, A and m are each as defined above.

The organopolysiloxanes (2) are preferably those of the general formula

HO(R₂SiO)ₙH (IV),

where R is as defined above and
n is an integer from 20 to 500.

Typically, mixtures (1) and (2) are not homogeneous, but rather are turbid biphasic mixtures even when heated. The generation of very small droplets of the dispersed phase prevents the dispersion obtained from dividing into two macroscopic phases. The associated generation of large interfaces between dispersed and continuous phase additionally ensures a maximum reaction rate and controllability/reproducibility of the reaction. For this purpose, average particle sizes preferably below 1 mm must be generated. The dispersed phase preferably has an average particle size below 100 μm, more preferably below 10 μm, and most preferably below 1 μm. The dispersions are preferably no longer transparent in a layer thickness of more than 2 cm. In this context, “no longer transparent” means that a barcode is no longer discernible. In order to achieve these particle sizes, various methods can be used in order to introduce the energy/work needed for this purpose into the system. These may be conventional stirrer and/or mixer units. In addition, dispersing units can be used. Useful for this purpose are in principle all homogenizers known from the prior art, for example, high-speed stirrers, high-performance dispersing units (for example, those obtainable under the IKA Ultra-Turrax® brand), dissolver systems and other rotor-stator homogenizers and also high-pressure homogenizers, shakers, vibration mixers, ultrasound generators, emulsifying centrifuges, colloid mills or atomizers. The homogenization can be effected either in the reaction chamber by immersing the dispersing unit into the reaction mixture, or outside the reaction chamber by passing the reaction mixture through a dispersing unit continuously in circulation. In addition to the dispersing unit, a conventional stirrer can ensure further mixing.

The mixing ratio of (1):(2) can vary over a very wide range and is guided by the amine group density of the target products. In the inventive process, organopolysiloxane (2) is therefore preferably used in amounts of from 20 to 500 mol, from 20 to 200 mol, per mole of aminoalkylsilane hydrolyzate (1).

In batchwise stirrer processes, the metering sequence is not critical, but preference is given for practical reasons to metering aminoalkylsilane hydrolyzate (1) onto the already introduced organopolysiloxane (2).

The reaction (ii) between (1) and (2) is carried out in the presence of basic catalysts. After preparation of the dispersion from (1) and (2), basic catalyst (3) is therefore added. To perform the reaction (ii) of (1) with (2) within economically viable times, a basic catalyst (3) which greatly accelerates the redistribution of the siloxy groups is required. In principle, it is possible to use all known basic catalysts, useful for preparing aminoalkylpolysiloxanes. However, preference is given to alkali metal hydroxides, alkali metal alkoxides, and alkali metal siloxanolates.

Examples of alkali metal hydroxides are potassium hydroxide and sodium hydroxide. Examples of alkali metal alkoxides are sodium methoxide and sodium ethoxide. An example of an alkali metal siloxanolate is sodium siloxanolate.

The basic catalysts (3) are preferably used in the process in an amount of from approx. 1 to 500 ppm, more preferably from 40 to 250 ppm, based in each case on the mixture of (1) and (2).

The reaction between components (1) and (2) is preferably performed in the range from 50° C. to 150° C., more preferably from 70° C. to 120° C., and at the pressure of the surrounding atmosphere, i.e. at about 1020 hPa, or at higher or lower pressures if desired. The reaction time is preferably from 2 to 60 minutes.

The reaction times for preparation of aminoalkylpolysiloxanes by base-catalyzed equilibration are usually several hours to achieve complete equilibration. Such processes are typically implemented noncontinuously in a batchwise process, since, for example, long heating and cooling phases (likewise within the range of hours) of the stirrer are barely of any significance compared to the long reaction time. However, the situation changes significantly when the reaction time is significantly shorter than the heating and cooling phases. In the process of the invention, the reaction times are typically in the range from a few minutes to about one hour. Not least owing to this speed, the process is particularly suitable for performing continuous methods. In this case, the reactants and the catalyst, which may be brought to the desired temperature separately by means of preheaters, are conducted continuously into a heated reaction chamber optionally equipped with mixing elements, in which the reaction takes place with the establishment of the desired residence time before the reaction products are removed from the reaction chamber continuously to the same degree and the catalyst is deactivated. For this type of continuous preparation mode, the process according to the invention is therefore also very suitable because the amount of volatile constituents in the reaction mixture is very low, preferably below 1% by weight a range which is normally arrived at only through downstream distillative processes. This allows vacuum methods and purge gas streams to be dispensed with in most cases. Such continuous processes can be carried out, for example, in loop reactors, kneaders, extruders, continuous batch reactors and batch reactor batteries, flow tubes, tubular reactors, microreactors or circulation pumps, or in any combinations thereof.

Preference is given to stopping the inventive reaction at the clearing point. A substantially clear mixture is achieved when the mixture has a Monitek turbidity value of ≦3.7 ppm. The turbidity value is measured with the Monitek optical analyzer by comparative measurement against a reference suspension of kieselguhr in water. The measurement is reported in ppm of kieselguhr.

The reaction is stopped by deactivating the catalyst on attainment of the clearing point (homogeneous organopolysiloxane). In principle, this can also be done later, which, though, apart from the time loss, also has the consequence of an increase in the volatility and in the viscosity, which is not preferred. It has been found that, surprisingly, redistribution of the siloxy groups at the clearing point is already so far advanced that no significant amounts of adjacent aminoalkylsiloxy groups, as are present in the hydrolyzate (1) are detectable. The catalyst (3) can be deactivated with all neutralizing agents which are useful for these purposes.

The basic catalyst can be deactivated by the addition of neutralizing agents which form salts with the basic catalysts. Such neutralizing agents may, for example, be carboxylic acids or mineral acids. Preference is given to methanesulfonic acid, and to carboxylic acids such as acetic acid, propanoic acid, and hexadecanoic and octadecanoic acid.

The basic catalyst can be deactivated by the addition of neutralizing agents which form salts which are soluble in the amine oils obtained and thus do not generate any turbidity whatsoever. Examples of such neutralizing agents are long-chain carboxylic acids, liquid at room temperature, such as n-octanoic acid, 2-ethylhexanoic acid, n-nonanoic acid and oleic acid, hexadecanoic or octadecanoic acid, carbonic esters such as propylene carbonate, or carboxylic anhydrides such as octenylsuccinic anhydride. Further examples are triorganosilyl phosphates, preferably trimethylsilyl phosphates, and triorganophosphates, preferably mixtures of mono-, di- and triisotridecyl phosphates (obtainable under the name Hordaphos® MDIT from Clariant). The trimethylsilyl phosphates used are preferably compositions consisting essentially of

0-50% by weight of monosilyl phosphate of the formula:

[(CH₃)₃SiO](HO)₂P═O,

20-100% by weight of disilyl phosphate of the formula:

[(CH₃)₃SiO]₂(HO)P═O, and

0-70% by weight of trisilyl phosphate of the formula:

[(CH₃)₃SiO]₃P═O,

where the total amount is 100% by weight.

The amount of neutralizing agents needed is guided by the amount of basic catalysts (3) used and is preferably from 0.05% to 0.50% by weight, preferably from 0.15% to 0.30% by weight, based in each case on the total weight of the reaction mixture. The neutralization can be effected before or after the cooling of the reaction mixture.

The aminoalkylpolysiloxanes obtained by the process according to the invention are preferably those formed from units of the general formula

$${A}_{z} {{R}_{x} ( {OR}^{1} )}_{y} {SiO}_{\frac{4 - ( x + y + z )}{2}} , \qquad ( V )$$

where R, A, x and y are each as defined above,
z is 0 or 1,
   with the proviso that an average of at least two A radicals and at least two R¹O radicals per molecule are present.

In the process of the invention, the aminoalkylpolysiloxanes are preferably those of the general formula

HO(ARSiO)ₘ(R₂SiO)ₙH (VI),

where R, A, m and n are each as defined above.

The inventive aminoalkylpolysiloxanes preferably have a viscosity at 25° C. of at least 100 mPa·s, more preferably 1000-500,000 mPa·s, and most preferably 5000-200,000 mPa·s. They preferably contain 0.01-0.80 meq, more preferably 0.03-0.60 meq of amine base per gram of aminoalkylpolysiloxanes. The range is most preferably 0.05-0.40 meq/g.

The aminoalkylpolysiloxanes obtained by the process preferably have a residual volatility of less than 1% by weight, more preferably less than 0.7% by weight, and most preferably less than 0.5% by weight. The residual volatility is a thermally determined value and is defined as the amount of volatile constituents in % by weight in the course of heating of an amount of sample of 5 g at 120° C. within a period of 60 min (120° C./5 g/60 min). The residual volatility is the value obtained prior to any additional physical processes of volatiles removal.

A large portion of the volatile constituents are cyclic siloxanes, octamethyltetrasiloxane (D4) being present in addition to higher cycles. The aminoalkylpolysiloxanes obtained by the process according to the invention preferably have a content of octamethyltetrasiloxane (D4) of less than 0.3% by weight, preferably of less than 0.2% by weight.

### EXAMPLE 1

400 g of an OH-terminated polydimethylsiloxane with a viscosity of 1000 mm²/s (25° C.) are mixed turbulently with 8.0 g of a likewise OH-terminated hydrolyzate of aminopropylmethyldimethoxysilane with an NH₂ concentration of 8.5 meq/g and an average chain length of 22 siloxy units, so as to form a highly turbid dispersion which is no longer transparent in a layer thickness of more than 2 cm such that a barcode is no longer discernible.

While stirring with a paddle stirrer at approx. 300 rpm, the mixture is heated to 100° C. and the reaction of the two components is started by adding 40 mg of KOH in the form of a 20% solution in ethanol. The dispersion becomes clear after 10 minutes, and the catalyst is immediately deactivated with 42 mg of acetic acid. The reaction product, which is slightly turbid as a result of the presence of potassium acetate, is cooled and then clarified by filtration. An amine oil with a viscosity of 6700 mm²/s (25° C.), an amine density of 0.17 meq/g and a volatility (5 g/1 h/120° C.) of only 0.2% by weight is obtained. In the high-resolution ²⁹Si NMR spectrum, at this very short reaction time, only approx. 3 mol % of aminopropylsiloxy block structures of the hydrolyzate are discernible at −22.40 ppm, whereas the main peak of the isolated aminopropylsiloxy units appears at −22.53 ppm as a new peak. This demonstrates the good separation of the aminoalkyl units used to give a state where only minimal amounts of volatile cyclic siloxanes have formed.

An aminoalkylsiloxane with randomly distributed dimethylsiloxane and aminopropylmethylsiloxane units and terminal silanol groups is obtained.

### COMPARATIVE EXAMPLE 1

### Analogous to U.S. Pat. No. 3.890.269 (=DE 2 339 761 A)

In a non-inventive manner, example 1 is performed with 400 g of a mixture of octamethylcyclotetrasiloxane and decamethylcyclopentasiloxane instead of an OH-terminated polydimethylsiloxane. Under otherwise identical conditions, the initially obtained dispersion does not become clear 10 minutes after catalysis with KOH solution at 100° C. The siloxane mixture deactivated by acetic acid separates into 2 phases. The measured volatility (5 g/1 h/120° C.) is 49% by weight. A usable aminoalkylorganopolysiloxane is not obtainable in this way. The separation of aminoalkylsilane hydrolyzate used as the reactant shows that it has reacted only insufficiently with the cyclosiloxanes. The viscosity of 3.2 mm²/s (25° C.) measured after homogenization of the dispersion also demonstrates completely inadequate polymer formation.

### COMPARATIVE EXAMPLE 2

### With Aminoalklsilane Instead of Aminoalklsilane Hydrolyzate (1)

Example 1 is repeated, except that 11 g of aminopropylmethyldimethoxysilane and not 8.0 g of its hydrolyzate are used. The content of aminoalkyl groups is identical at 0.17 meq/g. By the same procedure, an aminoalkylsiloxane product with 1780 mm²/s (25° C.) is obtained, which has a volatility of 1.3% by weight, which corresponds to 6 times the value of inventive example 1. The reaction progress cannot be discerned here with reference to a clearing point, since the reaction mixture is clear from the start. There is therefore a lack of an optical indicator.

### COMPARATIVE EXAMPLE 3

### Determination of the Stability

400 g of an OH-terminated polydimethylsiloxane with a degree of polymerization of 38 and 11 g of aminopropylmethyldimethoxysilane are used in a conventional manner, with 400 ppm of benzyltrimethylammonium hydroxide (40% solution in MeOH), over 5 hours at 100° C. and subsequent heat treatment at 150° C., to prepare 380 g of an aminopropylmethyl/dimethylpolysiloxane with a viscosity of 3850 mm²/s (25° C.). Nuclear resonance analysis shows an MeO/OH ratio of the chain ends of 42/58. In each case 50 g of this polymer and of the aminoalkylsiloxane from example 1 are subjected to an accelerated aging process at 70° C. for 7 days. The results are compiled in Table 1.

TABLE 1

| | | Comparative |
|---|---|---|
| | Example 1 | test 3 |
| Viscosity after preparation | 6700 | 3850 |
| [mm²/s] at 25° C. | | |
| Viscosity after heat treatment | 11,300 | 14,400 |
| [mm²/s] at 25° C. | | |
| Change in % | 69 | 374 |

The conventionally prepared aminoalkylsiloxane exhibits, in the rapid test, more than 5 times as great a viscosity rise compared to the product from example 1. It is thus much less stable than an aminoalkylsiloxane prepared in accordance with the invention.

### EXAMPLE 2

400 g of an OH-terminated polydimethylsiloxane with a viscosity of 5900 mm²/s (25° C.) are mixed with 5 g of the aminoalkylsilane hydrolyzate from example 1, so as to form a highly turbid dispersion, and, stirred as in example 1, is heated to 90° C. After adding 100 mg of a 20% solution of KOH in ethanol, the highly turbid solution becomes clear after 21 minutes. Shortly thereafter, as described in example 1, the catalyst is deactivated; the slightly turbid amine oil is clarified by filtration. At an amine content of 0.10 meq/g, the product has a volatility of 0.3% by weight and a viscosity of 19,100 mm²/s (25° C.).

A sample of this product is heat treated at 70° C. for 7 days in order to test the tendency to self-condensation of the siloxanol groups. The heat treatment causes a viscosity rise to 30,800 mm²/s (25° C.), meaning an average chain extension by only approx. 15%. The aminoalkylsiloxane with randomly distributed dimethylsiloxane and aminopropylmethylsiloxane units and terminal silanol groups thus obtained is accordingly storage-stable.

### EXAMPLE 3

In order to check the performability of the process under even milder conditions, example 2 is repeated at 60° C. except that the amount of KOH is doubled. Up to attainment of the clearing point, the reaction mixture needs 54 minutes, and the catalyst is then deactivated (analogous to example 2). At, of course, the same amine content, the volatility is again 0.3% by weight, the viscosity 18,700 mm²/s (25° C.). In the ²⁹Si NMR, no block structures are detectable any longer at −22.40 ppm, whose redistribution can therefore be achieved smoothly even at a mild 60° C., long before the status of equilibrium has been attained, which is clearly evident by the low volatility.

### EXAMPLE 4

400 g of a methyl-terminated polydimethylsiloxane with a viscosity of 2000 mm²/s (25° C.) are mixed thoroughly with 10.0 g of an OH-terminated hydrolyzate of aminoethylaminopropylmethyldimethoxysilane with 2460 mm²/s (25° C.), so as to form a highly turbid dispersion, and heated to 100° C. with stirring (300 rpm). After adding 60 mg of KOH dissolved in ethanol, the initially very turbid mixture becomes clear after 9 minutes. The catalyst is then deactivated with 85 mg of acetic acid. After cooling potassium acetate is filtered off to obtain a clear oil with a viscosity of 1100 mm²/s (25° C.), an amine density of 0.25 meq/g and only 0.3% by weight volatility (5 g/1 h/120° C.).

### EXAMPLE 5

Example 4 is repeated with 400 g of a low-viscosity OH-terminated polydimethylsiloxane with approx. 40 siloxy units instead of the highly viscous silicone oil. For the catalysis, 20 mg of sodium methoxide dissolved in methanol are also used. After 47 minutes, the clear reaction product is neutralized with 0.24 g of Hordaphos MDIT. The mixture reaches a viscosity of 140 mm²/s (25° C.) at a volatility of 0.7% by weight and an amine number of 0.26 (meq/g).

### EXAMPLE 6

100 g of the OH-terminated polydimethylsiloxane used in example 5 and 300 g of a further OH-terminated polydimethylsiloxane with 560 mm²/s (25° C.) are mixed with 10 g of the same aminoalkylsilane hydrolyzate (from example 4), so as to form a highly turbid dispersion, and heated to 85° C. with stirring. The addition of the same amount of sodium methoxide (example 5) affords, after 64 minutes, a clear reaction mixture which is neutralized immediately with 0.24 g of Hordaphos MDIT. At a volatility of 0.8% by weight and an amine number of 0.26 (meq/g), the resulting amine oil now has a viscosity of 790 mm²/s (25° C.).

### EXAMPLE 7

98.79% by volume of an OH-terminated polydimethylsiloxane having a viscosity of 5900 mm²/s (25° C.) and 1.18% by volume of the aminoalkylsilane hydrolyzate from example 1 were mixed continuously in a tubular reactor to give a turbid dispersion and reacted continuously with addition of 0.02% by volume of sodium methoxide dissolved in methanol (30%) in the tubular reactor (internal diameter 80 mm, height 500 mm, volume approx. 2.5 l) at internal reactor temperature 80° C., in the course of which the reaction mixture clarified just before it reached the exit from the reaction chamber. The catalyst was deactivated with 0.01% by volume of acetic acid.

Product discharge, product cooling and continuous catalyst deactivation were effected after an average residence time of 25 min. After a run time of the reactor of 6 h, it was shut down and the product collecting vessel was emptied. A colorless oil having a kinematic viscosity of 13,300 mm²/s (25° C.), a volatility (150° C./5 g/60 min) of 0.20% by weight and an amine number of 0.10 (meq/g) was obtained. In the ²⁹Si NMR, no block structures are detectable any longer at 22.40 ppm.

### EXAMPLE 8

### Determination of the Content of Volatile Octamethylcyclotetrasiloxane (D4)

A meaningful parameter for estimating the undesirable volatility of a siloxane product (content of thermally removable substances from a polymeric product) which can be employed is the spectrometrically determinable content of octamethylcyclotetrasiloxane (D₄). A suitable reference parameter is the quotient of the integral for D₄ at −19.3 ppm in the ²⁹Si NMR relative to the total integral of all dialkylsiloxy units (total D) in the range from −10 to −25 ppm. Since D₄ only constitutes a portion of the volatile constituents in the product, this percentage is generally also lower than the thermally determined value of the residual volatility.

The results for the aminoalkylpolysiloxanes of examples 1 to 6 (E1-E 6) and of comparative tests 1 and 2 (C1 and C2) are summarized in table 2.

TABLE 2

| | E 1 | E 2 | E 3 | E 4 | E 5 | E 6 | C 1 | C 2 |
|---|---|---|---|---|---|---|---|---|
| D₄/Total D in % by weight | 0.1 | 0.1 | 0.1 | 0.1 | 0.3 | 0.3 | 27 | 0.5 |

The low content of volatile D₄ in the aminoalkylpolysiloxanes which have not been heat-treated also shows the superiority of the process according to the invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing aminoalkylpolysiloxanes, comprising:
(i) mixing
(1) aminoalkylsilane hydrolyzate of the formula
(ARaSiO_{(3-a)/2})ₘ(R¹O_{1/2})ₚ (I) and
(2) linear and branched organopolysiloxane composed of units of the general formula
$${{R}_{x} ( {OR}^{1} )}_{y} {SiO}_{\frac{4 - ( x + y )}{2}} \qquad ( II )$$
to obtain a dispersion,
where
R individually are the same or different and are monovalent, optionally halogenated C₁₋₁₈ hydrocarbon radicals,
R¹ individually are hydrogen, or a C₁₋₄ alkyl radicals which optionally contain one or two non-adjacent oxygen atoms,
A is a monovalent SiC-bonded hydrocarbon radical which contains from 1 to 4 non-adjacent basic nitrogen atoms,
a is 0 or 1,
m is an integer from 2 to 500,
p is an integer of at least 2,
x is 0, 1, 2 or 3, and
y is 0 or 1,
with the proviso that an average of at least 10 silicon atoms per molecule are present in the organopolysiloxane (2),
(ii) reacting aminoalkylsilane hydrolyzate (1) and organopolysiloxane (2) in the dispersion in the presence of a basic catalyst (3) until a substantially clear mixture is obtained, and
(iii) stopping the reaction by neutralizing the basic catalyst (3).

2. The process of claim 1, wherein the aminoalkylsilane hydrolyzate (1) is one of the formula
HO(ARSiO)ₘH (III).

3. The process of claim 1, wherein the organopolysiloxane (2) is one of the formula
HO(R²SiO)ₙH (IV)
where n is an integer from 20 to 500.

4. The process of claim 2, wherein the organopolysiloxane (2) is one of the formula
HO(R²SiO)ₙH (IV)
where n is an integer from 20 to 500.

5. The process of claim 1, wherein at least one basic catalyst (3) is selected from the group consisting of alkali metal hydroxides, alkali metal alkoxides and alkali metal siloxanolates.

6. The process of claim 1, wherein a neutralizing agent is a carboxylic acid, triorganosilyl phosphate or triorganophosphate.

7. The process of claim 1, wherein (ii) the reaction is performed at a temperature of from 50 to 150° C. for a reaction time of from 2 to 60 minutes.

8. The process of claim 1, which is performed continuously.

9. The process of claim 1, wherein the aminoalkylpolysiloxanes obtained comprise those of the formula
HO(ARSiO)ₘ(R₂SiO)ₙH (VI)
where n is from 20 to 500.

10. An aminoalkylpolysiloxane of the formula
HO(ARSiO)ₘ(R₂SiO)ₙH (VI)
where
R individually are the same or different and are monovalent, optionally halogenated C₁₋₁₈ hydrocarbon radicals,
A is a monovalent SiC-bonded hydrocarbon radical which contains from 1 to 4 non-adjacent basic nitrogen atoms,
m is an integer from 2 to 500,
n is an integer from 20 to 500
with the proviso that the aminoalkylpolysiloxanes have a content of octamethylcyclotetrasiloxane (D₄) of less than 0.3% by weight without being subjected to a physical process for removal of volatiles.

11. The process of claim 1, wherein following step iii) and prior to any subsequent removal of volatiles, the residual volatility is less than 0.7 weight percent.
